(19) United States
(12) Patent Application Publication
(10) Pub. No.: US 2009/0287505 A1
(43) Pub. Date: Nov. 19, 2009

(54) SYSTEMS AND METHODS FOR EFFICIENT COMPUTER-AIDED ANALYSIS OF MEDICAL INFORMATION

(76) Inventor: Christopher H. Wood, Seattle, WA (US)

Correspondence Address: PERKINS COIE LLP;PATENT-SEA, P.O. BOX 1247, SEATTLE, WA, 98111-1247, US

(21) Appl. No.: 12/466,320

(22) Filed: May 14, 2009

Related U.S. Application Data
(60) Provisional application No. 61/127,734, filed on May 14, 2008.

(51) Int. Cl. G06Q 50/00; G06Q 30/00; G06Q 99/00; G06K 9/00

(52) U.S. Cl. 705/3; 705/2; 382/128

(57) ABSTRACT

Systems and methods for efficient computer analysis of medical information are disclosed. A computer-implemented method in accordance with a particular embodiment includes receiving an indication of a patient study and associated modality corresponding to a patient. The method can further include associating multiple analysis services with the patient study, based at least in part on a characteristic feature of the patient study, a characteristic feature of the modality, and a characteristic feature of the services. Information corresponding to the patient study and the matched services is presented to a user.

### CROSS-REFERENCE TO RELATED APPLICATION(S)

This application claims the benefit of the assignee's U.S. Provisional Patent Application No. 61/127,734, filed May 14, 2008 (attorney docket number 59958-8001.US00), incorporated herein by reference.

### BACKGROUND

Prior to the advent of computers, medical radiographs or X-rays were captured and stored using photographic film. Photographic film has several drawbacks, however, including the cost of the medium itself as a largely non-renewable resource, image processing delay times, fragility, cumbersome handling characteristics, and the difficulty associated with rapidly transferring film from one location to another.

The evolution of computers has facilitated the concomitant evolution of digital medical imaging techniques or modalities, such as digital X-rays and digital mammography, Computed Tomography (CT), Positron Emission Tomography (PET), and Magnetic Resonance Imaging (MRI). In such imaging modalities, medical information is captured and stored as digital data, which provides many advantages over photographic film. For instance, digital imaging data can be inexpensively and rapidly stored and transferred, readily displayed and manipulated on a display monitor, and efficiently electronically processed.

The ease with which digital medical imaging data lends itself to electronic processing has resulted in the development of computer-based medical image processing tools or services. Such services are directed toward helping medical professionals such as radiologists to more accurately and/or more efficiently diagnose, analyze, and/or evaluate their patients' state or condition. Representative examples of such services include software directed toward brain ventricle volume computation, tumor volume determination, and dynamic contrast agent uptake mapping. However, with the advent of a multiplicity of such services, it may be difficult, and/or cumbersome for a practitioner to take advantage of the services in an efficient manner. Accordingly, a need exists for systems and methods that facilitate efficient medical imaging service management.

### BRIEF DESCRIPTION OF THE DRAWINGS

FIG. 1 is a schematic diagram of an overall system configured to link patient data with suitable processing services in accordance with an embodiment of the disclosure.

FIG. 2 is a block diagram schematically illustrating a worklist processing system component of the overall system shown in FIG. 1, in accordance with a particular embodiment of the disclosure.

FIG. 3 is a block diagram schematically illustrating components of a study analysis workstation configured in accordance with an embodiment of the disclosure.

FIG. 4 is a flow diagram illustrating a process for associating analysis tools with patient study information in accordance with an embodiment of the disclosure.

FIG. 5 is a flow diagram illustrating details of a particular aspect of an embodiment of the process shown in FIG. 4.

FIG. 6A is an illustration of a screen display presenting information for associating patient studies with analysis tools in accordance with a particular embodiment of the disclosure.

FIG. 6B is an illustration of a screen display presenting information for associating patient studies with analysis tools in accordance with a further particular embodiment of the disclosure.

### DETAILED DESCRIPTION

Medical practitioners are often called upon to analyze computer-based image data that depict patient physiology and associated information, typically referred to as a patient study. For example, radiologists typically interpret a wide variety of images on a daily basis. These images may be acquired using different modalities, e.g., x-ray, MRI, CT, PET, and others. These images may also be of different anatomical areas (e.g., the knee, brain, GI tract and others), and/or may have been acquired for a variety of clinical reasons (e.g., tissue damage, suspected tumor, and others). For each of the foregoing characteristics of the images, there may exist multiple corresponding analysis tools that are suitable for interpreting the image data. For example, in a representative clinical situation, there may be ten, twenty, or even more services that are relevant (but not necessarily ideal) for analyzing the patient studies that a radiologist will consider during a given period of time. Due to the substantial number of already-existing image analysis services, as well as continued efforts to develop enhanced or new services, a radiologist may have a limited knowledge of the range and/or capabilities of the image analysis services that are available at any given time. The complexity of the radiologist's job may be significantly simplified if a range of software services were easily accessible and appropriately matched to the corresponding patient study. Aspects of the present disclosure provide these services to the radiologist or other practitioner in an efficient, intuitive way.

A software system in accordance with a particular embodiment can search for and find image interpretation services that may be useful to a clinician who is responsible for interpreting a patient study. The search can be based upon information describing a medical imaging study. The resulting list of recommended services can be presented to the clinician, who then decides which services to use.

Image interpretation services may include:
Specialized software applications applicable to a particular type of study
Archived cases that are similar to the study at hand
Published literature relevant to the study at hand
Professional over-read services (e.g., expert consulting) relevant to the study at hand

In a particular embodiment, the software system searches for and finds services based on attribute information contained in meta-tags (or other sources of metadata), and/or other data elements. For example, a software application that has been tagged as being useful for analyzing MRI images of the knee can be recommended when a clinician is viewing a knee MRI study. The software system can automatically extract information about the study being viewed by examining metadata associated with the study. This metadata can be in any format, but will typically be stored in a DICOM image header or in the hospital's information system in HL7 format.

The system may include components for:

1. Extracting and parsing study metadata

2. Storing, tagging and indexing services

3. Matching services to studies

4. Recommending services that may be of use

Many embodiments of the disclosure described below may take the form of computer-executable instructions, including routines executed by a programmable computer. Those skilled in the relevant art will appreciate that some or all of these embodiments can be practiced on computer systems other than those shown and described below. The disclosed methods can be carried out by a special-purpose computer or data processor that is specifically programmed, configured or constructed to perform one or more of the computer-executable instructions described below. Accordingly, the term “computer” as generally used herein refers to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a CRT display or LCD.

Aspects of the disclosure can also be practiced in distributed environments, where tasks or modules are performed by remote processing devices that are linked through a communications network. In a distributed computing environment, program modules or subroutines may be located in local and remote memory storage devices. Aspects of the disclosure described below may be stored or distributed on computer-readable media, including magnetic or optically readable or removable computer disks. Data structures and transmissions of data are also encompassed within the scope of the disclosure, such as distribution electronically over networks.

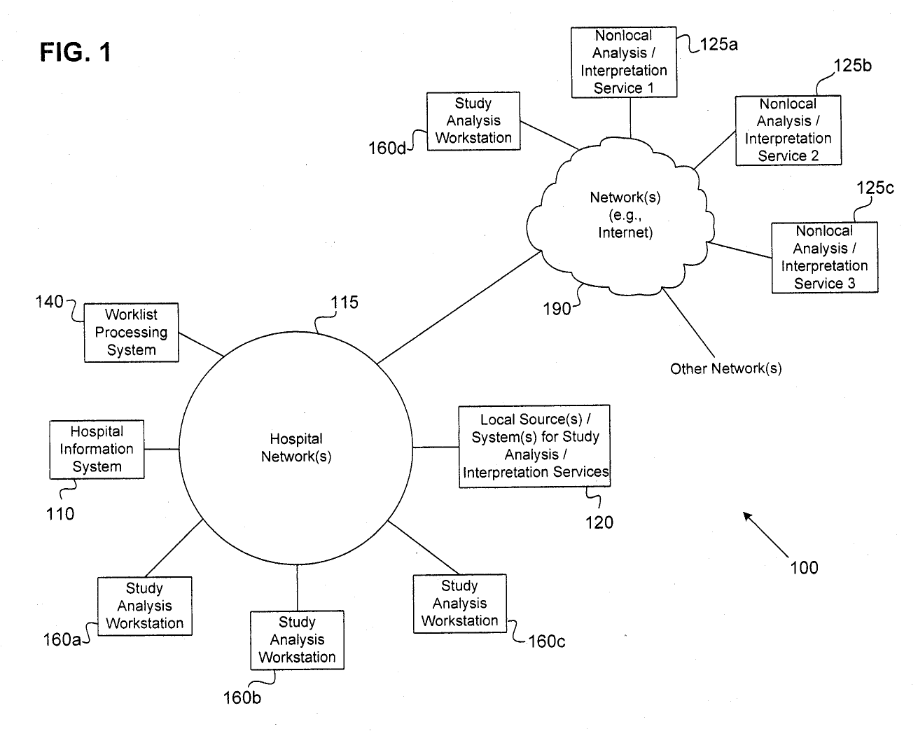

Certain specific details of further representative embodiments are set forth in the following description and in FIGS. 1-6B to provide a thorough understanding of various embodiments of the disclosure. Other details describing well-known structures, systems and methods often associated with data processing are not set forth in the following description to avoid unnecessarily obscuring the description of the various embodiments of the invention.

FIG. 1 is a schematic illustration of an overall system 100 that includes interconnected sub-systems and/or other components for linking medical image data with appropriate tools for analyzing, understanding, and/or interpreting the data. For example, the system 100 can include one or more hospital networks 115 that interact with in-hospital systems, and optionally, with other networks 190 (e.g., the Internet) outside the hospital network 115. The hospital network 115 can accordingly be connected with a hospital information system 110 that collects, stores, and makes available patient information. The hospital network 115 can also be connected to one or more study analysis workstations 160 (three such workstations are shown in FIG. 1 as workstations 160a-160c) at which a practitioner can analyze the patient data available from the hospital information system 110. The tools for analyzing the data may be accessible via a local services system 120. Such tools can include software for displaying and/or post-processing image data. For example, post-processing functions can include determining the size of a tumor, the composition of the tumor, the relative distance between the tumor and other anatomical landmarks, and/or other characteristics.

In particular embodiments, other analysis tools that are not available via the services system 120 may instead be available via the other networks 190. Such tools can reside on non-local service systems 125 (three of which are shown in FIG. 1 as service systems 125a-125c). For example, the hospital or other healthcare facility may wish to access such tools via the other networks 190 rather than purchasing the tools and storing the tools on the hospital network 115. As a result, such tools may be located remotely from the hospital. In particular embodiments, other study analysis workstations (e.g., study analysis workstation 160d) may also be located remotely from the hospital and connected via the other network 190.

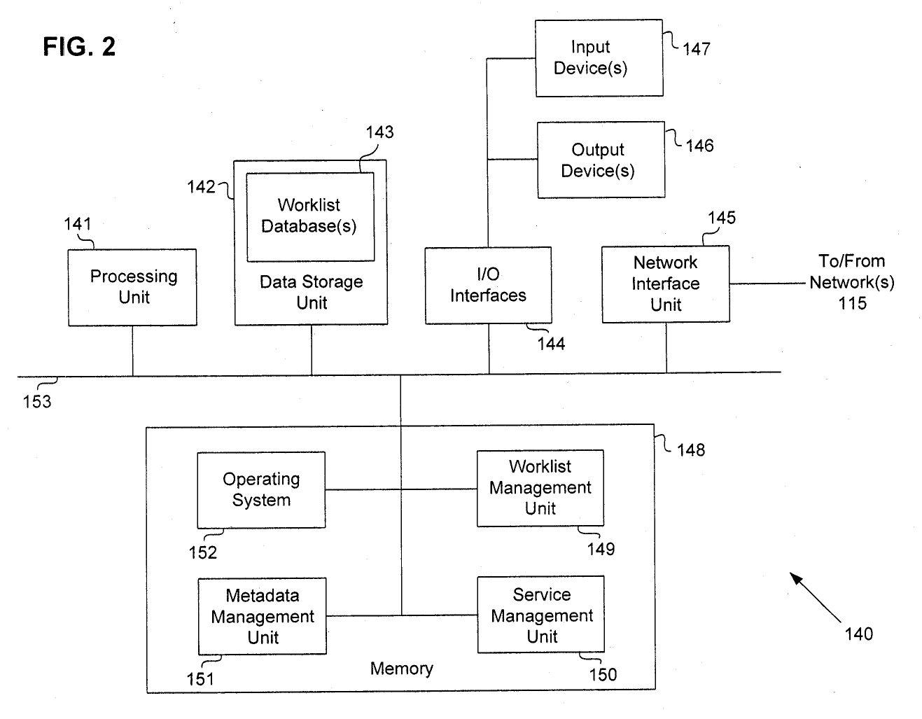

The overall system 100 further includes a worklist processing system 140 that connects the patient image or other data (e.g., stored at the hospital information system 110) with the appropriate analysis tools or services (e.g., stored at the local service systems 120 and/or the non-local service systems 125). The results determined by the service systems 120, 125 are then presented at the study analysis workstations 160 for review by the appropriate practitioner (e.g., a radiologist). Further details of subsystems and associated methods are described below with reference to FIGS. 2-6B.

FIG. 2 illustrates representative components of an embodiment of the worklist processing system 140 initially described above with reference to FIG. 1. The worklist processing system 140 can include a processing unit 141 that handles a flow of data via a bus 153. The system 140 can further include one or more data storage units 142 that in turn include one or more worklist databases 143. Each worklist database 143 can store worklist information that is obtained via the hospital network 115 from the hospital information system 110 (FIG. 1). The worklist information can in turn include information corresponding to a list of tasks for practitioners to conduct using patient study data. For example, the worklist database 143 can include a list of studies for which image data has been obtained, but not yet analyzed. Accordingly, the worklists at the worklist database 143 can represent a “to-do” list for one or more practitioners.

The information contained in the worklist database 143 can be arranged in any of a variety of manners. Typically, patient study information is tied to a particular patient, and then may be correlated with the practice group at the hospital responsible for initiating the patient study. In other embodiments, the patient study information may be correlated and/or categorized on the basis of other criteria. In any of these embodiments, the information may be readily identified, retrieved and presented to the practitioner for review and/or action. Accordingly, the system 140 can further include I/O interfaces 144, which in turn include one or more input devices 147 and one or more output devices 146. A network interface unit 145 facilitates the exchange of information via the hospital network 115.

Several other components (e.g., stored on a memory 148) assemble and/or interact with the worklists contained in the worklist database 143 via the bus 153. For example, a worklist management unit 149 can obtain worklist information from the worklist database 143. In a particular embodiment, the worklist management unit 149 can track information provided by the hospital information system 110 (FIG. 1) via the hospital network 115. For example, if a doctor or other practitioner orders a particular study (e.g., a CT scan), the worklist management unit 149 can identify and track this event. When the study is completed, the worklist management unit 149 can track this event as well. The worklist management unit 149 can then add the existence of the new study to the worklist from which a radiologist or other practitioner works, and, as the radiologist completes the associated analysis task(s), can remove the study from the practitioner's worklist or otherwise indicate that the analysis task(s) have been completed.

A service management unit 150, also shown in FIG. 2, can track which analysis services are available via the network 115. Accordingly, the service management unit 150 can provide information regarding these services and can provide links to the services themselves for access when the practitioner wishes to analyze image data using the services. In addition, if there is an opportunity to combine the results of multiple patient studies (e.g., overlaying CT scan results on PET scan results), the service management unit 150 can combine the data from multiple patient studies, creating a new patient study.

A metadata management unit 151 can obtain and process data associated with the patient studies and/or the analysis services in order to present associated service options to the practitioner. For example, in a typical embodiment, the metadata associated with different studies may appear in any of several possible standard data formats, or in no consistent data format. The metadata management unit 151 can extract the appropriate data and identify the modality of a particular patient study (e.g., a CT scan, PET scan, or other study) despite the fact that the data may be in a variety of formats. In particular, the metadata management unit 151 can extract data presented in any of a variety of standard formats (e.g., DICOM format or HL7 format), and/or data presented in other formats. In addition, if a new patient study is generated (e.g., by combining multiple sets of existing patient study data, as discussed above), the metadata management unit 151 can generate the appropriate metadata associated with the new study and coordinate storing the results of the study on the hospital information system 110 or elsewhere.

Still further, the metadata management unit 151 can extract data from the service software, to aid in linking the patient study with the appropriate service to be used for analyzing the study. For example, the metadata management unit 151 can extract information regarding the modality (e.g., MRI, CT scan or others), study type (e.g., knee, brain or others), indication, (e.g., tissue damage, tumor or others) and/or expected result (e.g., tumor size or others) which the particular service is appropriate for handling. The metadata management unit 151 can then identify the correlation between the patient study and the service or services that may be suitable for analyzing or otherwise post-processing the patient study data. For example, the metadata management unit 151 can compare keywords obtained from the patient study with keywords obtained from the potentially suitable services and identify matches. The keywords associated with the services may be obtained from metadata associated with the services, or from other sources (e.g., marketing materials). In some cases this information is first obtained manually, and in other cases, it can first be obtained automatically. In some embodiments, the information, once obtained, can be stored in a database so that it need not be regenerated each time a comparison is made. Instead, the metadata management unit 151 can compare keywords from the patient study with keywords in the database. In a particular embodiment, the metadata management unit uses a recommender algorithm, and identifies a match when a threshold number of keywords match, and/or when keywords of particular significance match. The actions of the metadata management unit 151, the service management unit 150, and the worklist management unit 149 can be coordinated by an operating system 152.

In particular embodiments, the body part, study description and/or modality of a particular patient study is compared with the same information obtained from multiple services to determine if a match (or matches) exists. In other embodiments, other characteristics of the patient study may be compared with corresponding characteristics of the services. The following is a non-exhaustive list of representative examples of suitable characteristics.
Information typically specified in DICOM fields such as modality, body part and study description
Information typically specified in HL7 fields such as patient clinical information
If there is a previous imaging study
Software used to interpret the previous imaging study
Information in the report associated with previous imaging study
Preferences of the Radiologist viewing the current study
Referring physician preferences and information
Image characteristics or features
Contrast agent used (if any)

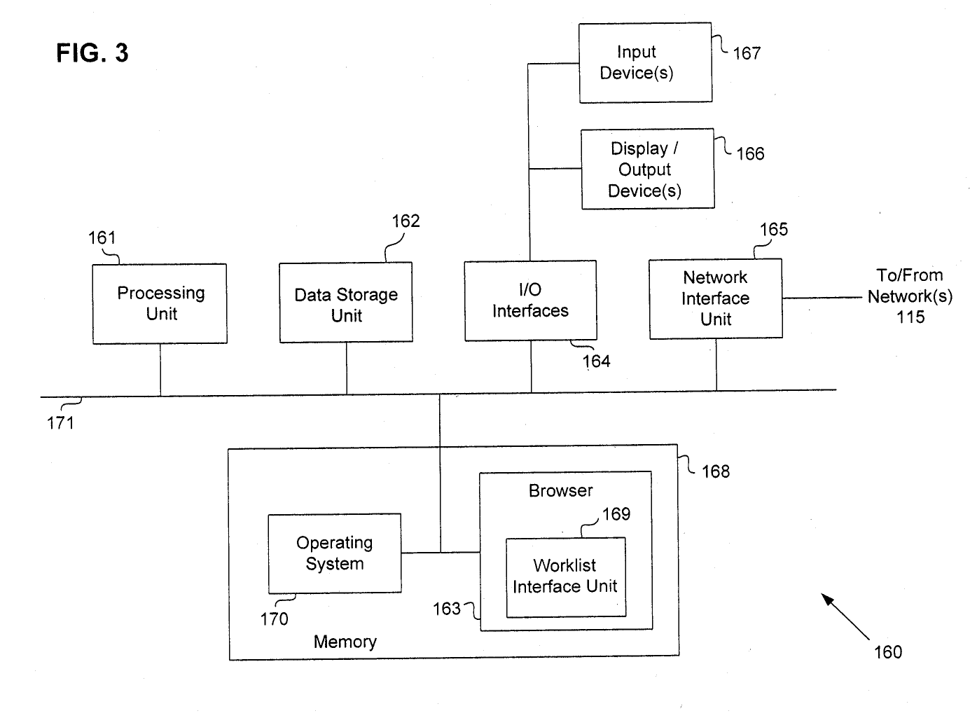

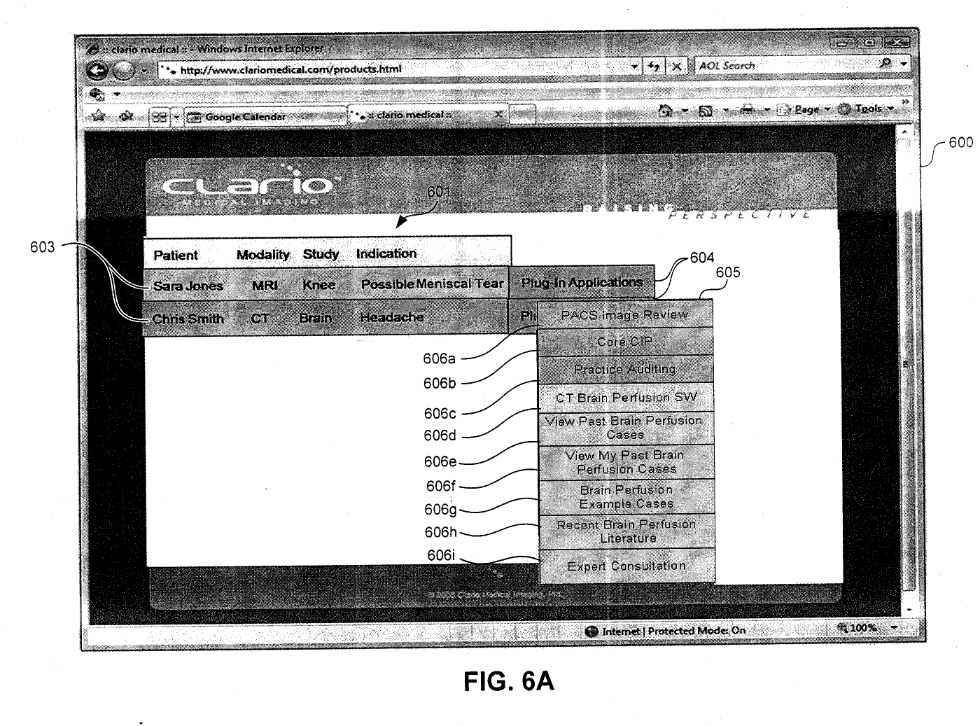

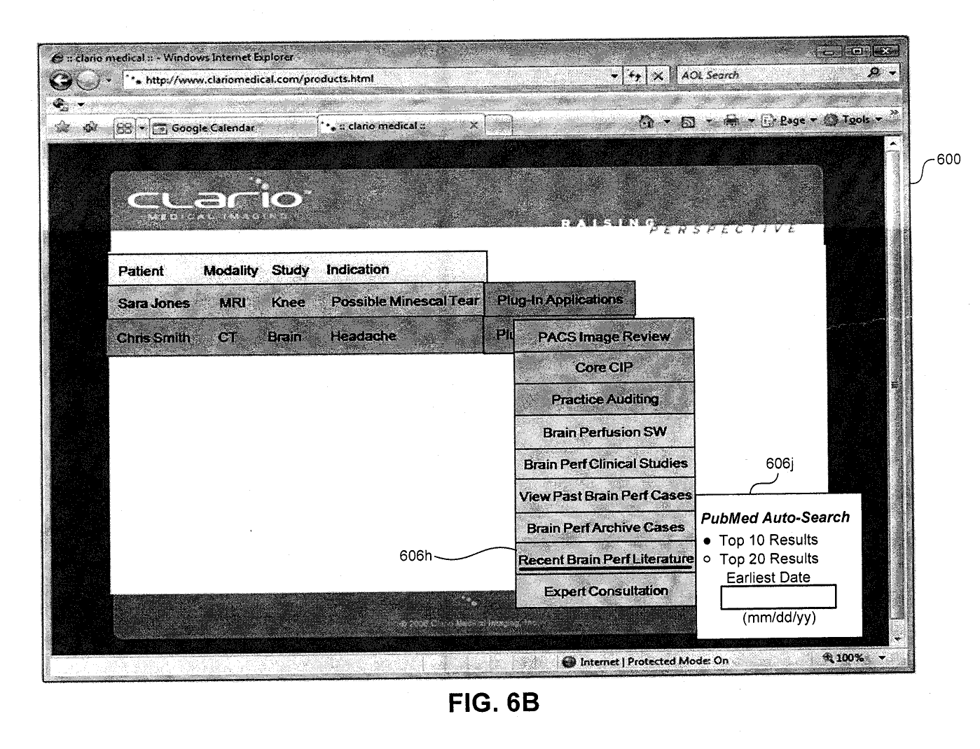

The information processed by the worklist management unit 149, the service management unit 150 and the metadata management unit 151 can be presented at one or more of the study analysis workstations 160, a representative one of which is shown in FIG. 3. The study analysis workstation 160 can include a processing unit 161, a data storage unit 162, I/O interfaces 164 (which can in turn include input devices 167 and display/output devices 166), a bus 171, and a network interface unit 165 for transmitting information to and from the network 115. An operating system 170 is resident on a memory 168, as is a browser 163. The browser 163 can include a worklist interface unit 169 that interfaces with the worklist management unit 149 (FIG. 2) to present information at the display/output devices 166, and receive information via the input devices 167. For example, the worklist interface unit 169 can present log-in cues to the practitioner, receive log-in information from the practitioner, and automatically present information at the display/output device that is consistent with a particular practitioner's preferences. Further details of the information provided by the worklist interface unit 169 are described later with reference to FIGS. 6A and 6B.

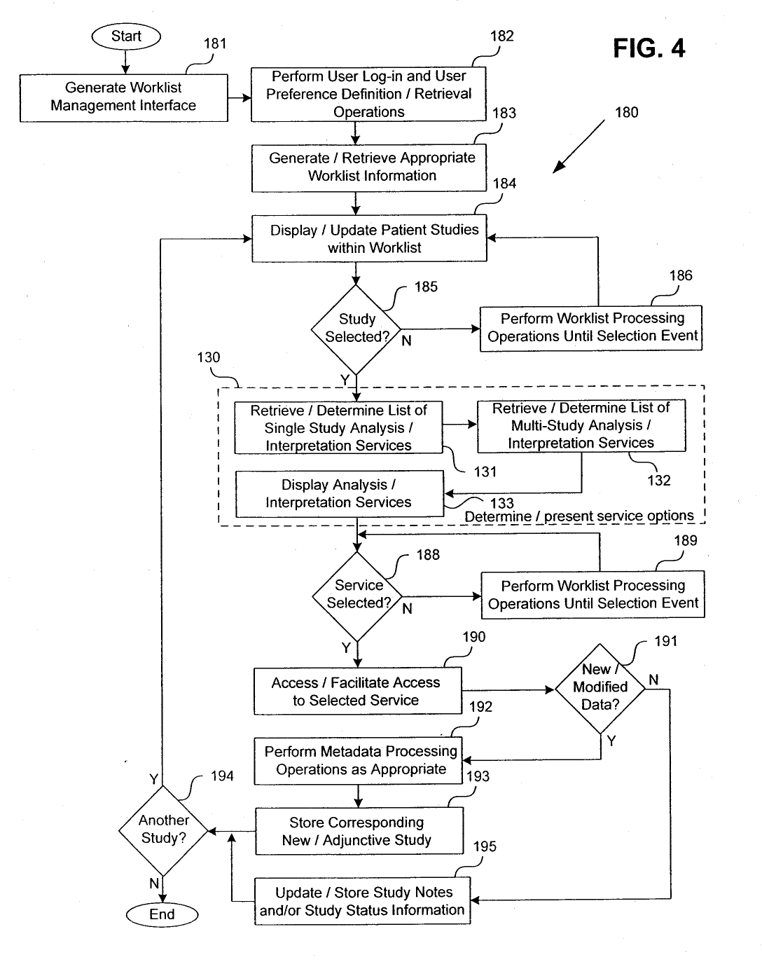

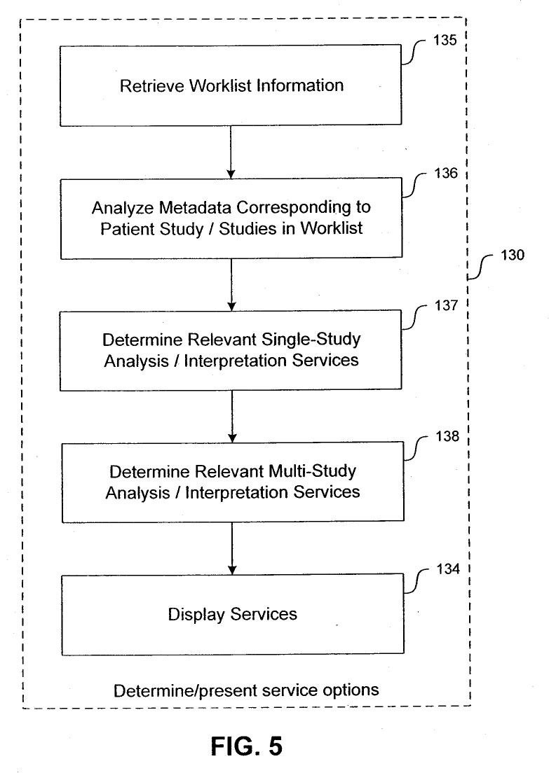

FIG. 4 is a flow diagram illustrating a process 180 for associating patient studies with appropriate services in accordance with a particular embodiment of the disclosure. The process 180 can be performed by the components described above with reference to FIGS. 1-3. The process 180 of FIG. 4 (and process 130 of FIG. 5) describe an algorithm for associating multiple analysis functions or services with a patient study based metadata or other data noted herein. The process 180 can include generating a worklist management interface (process portion 181) and then, via the worklist management interface, performing a user log-in process (process portion 182). Process portion 182 can also include defining and/or retrieving user preference information that is particular to an individual user and that is keyed to the user's log-in information. For example, individual users may wish to have information presented to them in a particular manner that the user can select and that the system can store and use the next time the user logs on. The user can also select filters or have filters automatically operate in a default mode. Such filters screen studies based on the identity of a particular patient, a particular day, a particular modality, and/or other screening parameters. In addition, particular users may wish to have only certain services presented to them, and/or may wish to have certain services never presented to them. Again, the system can receive these preferences, store the preferences, and automatically present information in accordance with these preferences when the user next logs on.

In process portion 183, the appropriate worklist information is generated and/or retrieved. The worklist information is a list of those studies that are to be processed, and can include the names of individual patients, the study conducted on the patient (e.g., a knee study), the modality via which the study was completed (e.g., an MRI) and the patient indication (e.g., the dysfunction identified by and/or prompting the study). In process portion 184, patient studies within the worklist are displayed and/or updated. For example, if a new patient study becomes available, the worklist can be automatically updated. If the practitioner has finished analyzing a particular study, that study can be removed from the worklist, or the presentation of that study at the display can be updated to indicate which analysis task or tasks have been completed.

Process portion 185 includes determining whether the practitioner has selected a particular patient study. If not, process portion 186 includes performing worklist processing operations (e.g., updating a display of the worklist) until a patient study is selected. Once a study is selected, the process further includes determining/presenting service options associated with the selected study (process portion 130).

Process portion 130 can in turn include retrieving and/or determining a list of study analysis, interpretation, and/or other post-processing services suitable for a single patient study (process portion 131). This task can be performed by determining a match between a particular study and the capabilities of one or more analysis tools. The comparison can be conducted on the basis of meta-tag (and/or other) information obtained from the study, and meta-tag (and/or other information) obtained from the analysis tool. When multiple options for services are found, the options can be ranked by the closeness of the match, how many other practitioners use each service, and/or other criteria. In a particular embodiment, a recommender system is used to provide the foregoing match, as discussed above. Such a system can also incorporate user-based preferences into the matching process, so that individual users are only presented with analysis tool options that they wish to select from, or, in another embodiment, are not presented with analysis tool options that they do not wish to select from. In particular embodiments, multiple studies may be available and accordingly, process portion 130 can include retrieving and/or determining a list of analysis, interpretation, and/or other post-processing services suitable for multi-study processing, e.g., if data from multiple studies are to be combined (process portion 132). In any of the foregoing embodiments, the available analysis, interpretation, and/or other post-processing services are displayed in process portion 133.

Process portion 188 includes determining whether a particular service (e.g., presented at process portion 133) has been selected by the practitioner. If not, process portion 189 includes performing the worklist processing operations until a service is selected. Once a service is selected, process portion 190 includes accessing and/or facilitating access to the selected service, and in at least some cases, executing the selected service. In particular, process portion 190 can include applying the selected service to the patient study to produce a particular result. For example, process portion 190 can include executing a volumetric analysis software program to estimate the volume of a tumor imaged in a CT scan.

Process portion 191 includes determining whether new or modified data (e.g., corresponding to overlaid CT scan and PET scan data) are available. If not, the process 180 continues with process portion 195, which includes updating and/or storing study notes and/or study status information, e.g., the results obtained during process portion 190. In process portion 194, it is determined whether another study is available at the displayed worklist. If so, the process returns to process portion 184 and if not, the process ends.

Returning to process portion 191, if new or modified data are available, process portion 192 includes performing metadata processing operations as appropriate. For example, if the result of the selected service provided in process portion 190 includes generating new data, process portion 191 can include generating the metadata associated with the newly generated data. Such data can include data corresponding to a combination of patient study information, for example, the combination of a CT image and a PET image. In process portion 193, the new or adjunctive study is stored, and the process continues with process portion 194.

FIG. 5 illustrates a flow diagram for performing process portion 130 (determining/presenting representing service options) in accordance with a particular embodiment. In this embodiment, process portion 130 includes retrieving worklist information (process portion 135), and analyzing metadata corresponding to one or more patient studies on the practitioner's worklist (process portion 136). In process portion 137, one or more single-study analysis and/or interpretation services are determined or identified. For example, if one or more analysis tools suitable for analyzing MRI data are available, these are identified in process portion 137. Process portion 138 is somewhat similar to process portion 137, but differs in that it determines relevant multi-study analysis and/or interpretation services. For example, if the practitioner wishes to use an analysis tool that works on combined data (e.g., CT scan data combined with PET scan data), then process portion 138 identifies the appropriate analysis tool. Process portion 134 then includes presenting the available service options.

In a particular aspect of the embodiment shown in FIG. 5, process portions 135-138 can be run without displaying the services, e.g., in a background mode. Accordingly, the user (e.g., the practitioner) need not be presented with information particular to these processes as they are carried out.

FIG. 6A illustrates a display 600 at which information generated by the system 100 described above is presented. This information can include a worklist 601 that in turn includes modality, study, and indication information for multiple patients. Accordingly, the worklist 601 can include multiple summary lines 603, each of which include metadata corresponding to the modality, study, and indication associated with a particular patient. In the particular example shown in FIG. 6A, the worklist includes single studies for two individual patients. Sara Jones has had a knee study conducted using MRI, with an indication of a possible meniscal tear, and Chris Smith has had a brain study conducted via CT techniques with a headache indication. In other embodiments, the display 600 can present study information for more or fewer patients. When an individual patient has had multiple studies conducted, the entire list of studies can be presented at the display 600, or the display 600 can present only selected studies (e.g., only knee studies). In other embodiments, the worklist 601 can be tailored in other manners, for example, to reflect user preferences. In a particular embodiment the user (e.g., a practitioner) may wish to see only MRI studies, or only studies conducted with a CT modality. Accordingly, system can update the display 600 to reflect these preferences.

The display 600 can also include selectable applications tabs 604 associated with each of the summary lines 603. When the practitioner hovers over, clicks, or otherwise selects one of the selectable applications tabs 604, the system can present a drop-down menu 605 or other identifier list that includes multiple selectable tabs 606, representative ones of which are illustrated in FIG. 6A as tabs 606a-606i, each corresponding to a service that is suitable for the associated patient study, as summarized below.

### Tab 606a

Image Review Software—This can correspond to non-specialty software that displays images for visual inspection by the practitioner. Any study that has at least one image is typically offered this choice.

### Tab 606b

Core CIP (Clinical Image Processing)—This software can include an application that performs:
3D Surface or Volume Rendering, which creates 3D images from stacks of 2D image slices
Multi-Planar Reformatting (MPR), which creates views of images in a different plane than the one in which the images were acquired
Maximum Intensity Projection (MIP), which creates 2D projections from 3D volumes that highlight bright structures (such as blood vessels)
   Any study that has a stack of contiguous studies can be offered this choice.

### Tab 606c

Practice Auditing—This software can allow the user to access statistical information (about his/her practice) which is specific to this type of study. It also may allow for specific information about this study to be added to the database. For example, the user may use this service to find out how many brain perfusion studies resulted in additional testing, and which tests were ordered.

### Tab 606d

CT Brain Perfusion SW—This is specialized software designed to process contrast enhanced studies of the brain. Parametric maps and other quantitative information are typically computed using this software. Any CT study with contrast of the brain will typically be offered this software service.

### Tab 606e

View Past Brain Perfusion Clinical Cases—When selected, this service presents previous cases from the same hospital or imaging center.

### Tab 606f

View My Past Brain Perfusion Cases—When selected, this service presents previous cases from the same hospital or imaging center that were interpreted by the same radiologist who is reading the current case.

### Tab 606g

Brain Perfusion Example Cases—When selected, this service presents Example cases that are available through a web-based service which will retrieve example cases which may be helpful in the interpretation of the current case.

### Tab 606h

Recent Brain Perfusion Literature—When selected, this service presents abstracts presented or articles published on the use and performance of Brain Perfusion software in diagnosing and managing patients. Further, the system may use the metadata or other data noted herein to automatically identify potentially relevant medical literature for the practitioner to view and/or purchase.

### Tab 606i

Expert Consultation—When selected, this service provides a connection to an expert in the interpretation of Brain Perfusion studies. Thus, the system matches metadata associated with the patient study indicating that the study is for brain perfusion with experts listed in a database as being brain perfusion experts. This service may also provide information about whether this expert is on-line. Thus, the practitioner may easily electronically forward or export the patient study to the expert to obtain assistance or a second opinion. This service may list a separate fee for engaging each of multiple experts. Further, for each expert engaged through the present system, the expert may provide a percentage of any fees to the company offering the present system. Thus, the present system may receive some compensation for such referrals.

FIG. 6B illustrates the display 600 after the practitioner has selected tab 606h (“Recent Brain Perfusion Literature”). In this instance, the system presents an additional window 607 corresponding to a PubMed search function. The practitioner can accordingly use the window 607 to conduct a literature search on recent brain perfusion literature, without exiting the worklist 601 presented at the display 600. The results of the search may be presented in a separate window, with the worklist 601 provided in the background. The system may generate FIGS. 6A and 6B using known algorithms, such as using HTML coding/tags or other display description languages, or using display descriptors in operating systems such as Microsoft Windows.

In one embodiment, the system provides an on-line or web-based store for purchasing the various services or analysis functions. The purchasing can include one use purchases for using a selected service only for a current patient study, and a multiple-use-license for using the selected service. The multiple-use-license could take any known form, such as use of the service for an unlimited number of patient studies over a selected time period or for a predetermined number of patient studies with no time limit. For each sale through the on-line store, the provider of the service may provide a percentage of any sale under the present system to the company offering the present system and on-line store, wherein the percentage may be greater for one-time use sales versus multiple-use-license sales. The on-line store may track purchases by similar practitioners and make recommendations, such as via the recommender algorithm. The on-line store may include many common features employed in on-line stores, such as a web server that accesses a database that stores displayable web pages that describe products/services for sale. Further, the on-line store may include other features, such as a shopping cart model, a secure site for processing credit card transactions and storing a user account data, etc.

One feature of the systems and methods in accordance with several of the foregoing embodiments is that they can include automatically correlating, linking, and/or displaying patient studies with appropriate tools for analyzing or otherwise post-processing the data included in the patient studies. One advantage of this arrangement is that the practitioner need not track which tools are appropriate for particular patient studies. Instead, the system can automatically perform this function for the practitioner. This arrangement can accordingly reduce the practitioner's workload. Another potential advantage of this arrangement is that, as new tools become available, they can automatically appear in a linked manner with the appropriate patient data. Accordingly, the practitioner may more be readily exposed to these tools as they become available. This feature can be further enhanced by allowing the system to access tools that may not necessarily be stored on a local (e.g., hospital) network. For example, as discussed above with reference to FIG. 1, such tools may be accessed via the Internet or other networks and accordingly, the universe of available analysis tools can be expanded, as can the practitioner's access to those tools.

Still another advantage of certain embodiments of the foregoing arrangement is that, while aspects of the analysis tool selection process are automated, the practitioner remains part of the selection process. For example, the practitioner selects which of several suitable tools he or she will use to analyze a particular study. This is unlike some existing systems, which automatically execute a particular analysis program each time a study is called up. Accordingly, embodiments of the present system can winnow a potentially long list of analysis tools down to those that are suitable for a particular study, but still allow the practitioner to select which of those suitable tools to use in a particular instance.

Another feature of at least some of the foregoing embodiments is that they can include provisions for tailoring the information presented to the practitioner in accordance with the specific practitioner's preferences. For example, as discussed above, the practitioner may wish to see only certain analysis tools, certain patient studies, certain modalities, and/or certain other features or combinations of features. Embodiments of the foregoing system can readily receive such preferences via the user interface, and can readily present information in accordance with these preferences by appropriately tailoring the worklist information and selectable tabs associated with the worklist. If the practitioner changes his or her preferences, the system can receive change requests and store such requests so as to be available the next time the practitioner logs into the system.

Still another advantage of at least some of the foregoing embodiments is that they can include the ability to generate new patient data (e.g., a new patient study), for example, by combining two or more existing patient studies. This arrangement can give the practitioner the flexibility to take additional advantage of the strengths provided by different studies (e.g., as discussed above, a CT scan in combination with a PET scan). Once such information is generated, it can automatically be stored as a new patient study and can accordingly be available for other practitioners to access.

From the foregoing, it will be appreciated that specific embodiments have been described herein for purposes of illustration, but that various modifications may be made in other embodiments. For example, the system can be implemented in environments other than a hospital in certain embodiments. Aspects of the system described in the contexts of worklists or worklist management functions can be carried out in other contexts as well (e.g., without necessarily requiring a worklist). Tasks described above as being carried out by particular units in certain embodiments may be carried out by other units in other embodiments. The information presented at the display 600 can be presented in manners other than those specifically shown in the Figures. The data shown in the Figures and described in the associated text can be different in other embodiments. Information used to identify analysis tools and/or services that are relevant to particular patient studies may be obtained from header information, meta-tags, and/or other sources, e.g., from the patient study data itself. The patient study information and the services information that are compared to determine if a match exists between a patient study and one or more services can be different than that specifically identified in the foregoing representative embodiments. For example, the information can include information directly from an image (e.g., a fuzzy image can be matched with a service that is suitable for handling fuzzy images). The services that are matched with a patient study can have characteristics and/or functions other than those described above. For example, one such service can include an image search service that identifies images having characteristics similar to those of the subject patient study.

Certain aspects of the foregoing embodiments may be combined or eliminated in other embodiments. For example, in some embodiments, the patient study data may be presented in the form of images (e.g., x-ray images) and in other embodiments, the images themselves need not be presented to the practitioner, and instead, the analysis tools can operate directly on the data without displaying it. Further, while advantages associated with certain embodiments have been described in the context of those embodiments, other embodiments may also exhibit such advantages.

The term “image”, as used herein, includes all visually perceptible data, including still images, videos, animations, etc., all of which may be in any electronic format. Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. Not all embodiments need necessarily exhibit such advantages to fall within the scope of the present disclosure. Accordingly, this disclosure can include other embodiments not expressly shown or described above. The above examples provide additional embodiments of the disclosure. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to add additional claims after filing the application to pursue such additional claim forms for other aspects of the invention.

1. A computer-implemented method for handling patient data, the method comprising:
receiving an indication of a patient study and associated modality corresponding to a patient;
associating multiple analysis functions with the patient study, based at least in part on: a characteristic feature of the patient study, a characteristic feature of the modality, and a characteristic feature of the functions,
wherein at least some of the multiple analysis functions correspond to a computer-implemented method for analyzing data of the patient study, and
wherein the multiple analysis functions are a subset of functions selected from a more numerous set of available analysis functions;
presenting to a user information corresponding to the patient study and the multiple analysis functions;
receiving from the user an indication of a selected one of the functions; and
initiating the selected function,
wherein the selected function operates on data of the patient study to generate analysis data for the user.

2. The computer-implemented method of claim 1 wherein the patient data includes diagnostically relevant image data,
wherein the patient study includes a patient name and an anatomical area,
wherein the modality includes an indication of a medical device associated with generating the image data,
wherein the multiple analysis functions include:
creating three dimensional images from multiple two dimensional image slices,
creating views of images in a different plane than a plane in which images were acquired, and
creating two dimensional projections from three dimensional volumes and highlighting certain depicted structures.

3. The computer-implemented method of claim 1 wherein the patient data includes medical image data,
wherein the patient study includes a patient name, an anatomical area, or both;
wherein the modality includes an indication of a medical device associated with the image data;
wherein the multiple analysis functions include:
processing contrast enhanced studies of the anatomical area;
presenting example images representing example cases, wherein the example images are available through a web-based service; or
presenting abstracts or articles published on contrast enhanced studies of the anatomical area or on software for analyzing contrast enhanced studies.

4. The computer-implemented method of claim 1 wherein the patient data includes medical image data,
wherein the multiple analysis functions include:
presenting statistical information for the user and related to the patient study,
presenting previous patient studies or cases from the same hospital or imaging center from which the medical image data originated, or
presenting previous patient studies or cases from the same hospital or imaging center from which the medial image data originated and which were interpreted by the user.

5. The computer-implemented method of claim 1 wherein the patient data includes image data,
wherein the patient study includes an anatomical area;
wherein the modality includes an indication of a medical device associated with the image data; and,
wherein the multiple analysis functions include connecting to a medical expert in analyzing image data from the medical device or related to the anatomical area, and wherein function includes providing an indication to the user whether the medical is on-line.

6. The computer-implemented method of claim 1, further comprising:
providing a web-based store for purchasing the multiple analysis functions, wherein the purchasing includes one use purchase for using the selected function for the patient study, and a multiple use license for using the selected function with an unlimited number of patient studies for a selected time period or for a predetermined number of patient studies.

7. The computer-implemented method of claim 1 wherein the patient data includes multiple medical images having different modalities or derived from multiple patient studies, and
wherein at least one of the multiple analysis functions include combining the multiple medical images to form a composite image.

8. A system for handling patient data associated with a patient, comprising:
a management unit configured to receive worklist information, wherein the worklist includes multiple items, and wherein each item in the worklist includes an indication of a patient study and one or more modalities corresponding to a patient;
a metadata management unit configured, for each item in the worklist, to:
(a) receive information corresponding to an identity of the study and an identity of the modality, and
(b) receive information corresponding to the capabilities of multiple analysis functions; and
at least one processing unit configured to associate multiple analysis functions with the patient study, based at least in part on a characteristic feature of the patient and/or the patient study, and a characteristic feature of the functions.

9. The system of claim 8 wherein the processing unit is configured to associate multiple analysis functions with the patient study based also on a characteristic feature of the modality, and wherein the patient data includes medical image data.

10. The system of claim 8, further comprising a user input portion and a user output portion, wherein the user input portion receives a user selection of one of the multiple analysis functions, and wherein the user output portion is configured to provide displayable data representing analysis of the patient data.

11. The system of claim 8, further comprising a filter portion, wherein the filter portion is configured to screen patient studies based on an identity of a particular patient, a particular time period, or a particular modality.

12. The system of claim 8, further comprising a filter portion, wherein the filter portion is configured to present only certain user-selected analysis functions, to never present certain user-selected analysis functions, or both.

13. A computer-readable medium storing instructions for a method, wherein the method causes a computer to display information for analysis by a medical service provider, the method comprising:
displaying a list of cases for analysis by the medical service provider, wherein the list includes multiple patients, multiple modalities, and/or multiple patient studies, and
wherein each case in the list of cases is associated with medial image data; and
for each case in the list of cases, displaying a subset of available services,
wherein the subset of available services are selected from a larger set of multiple services,
wherein the subset of available services for each case are selected based at least in part on a modality or study of the case, and,
wherein the multiple services include information services and image analysis services.

14. The computer-readable medium of claim 13 wherein each patient study includes a patient name and an anatomical area,
wherein each modality includes an indication of a medical device associated with generating the image data,
wherein the subset of available services include:
a software process for creating three dimensional images from multiple two dimensional image slices,
a software process for creating views of images in a different plane than a plane in which images were acquired, or
a software process for creating two dimensional projections from three dimensional volumes and highlighting certain depicted structures.

15. The computer-readable medium of claim 13 wherein each patient study includes a patient name, an anatomical area, or both,
wherein each modality includes an indication of a medical device associated with the image data;
wherein the subset of available services include:
a software process for processing contrast enhanced studies of the anatomical area;
a software process for presenting example images representing example cases, wherein the example images are available via a computer network; or
a service for presenting abstracts or articles published on contrast enhanced studies of the anatomical area or on software for analyzing contrast enhanced studies.

16. The computer-readable medium of claim 13 wherein the subset of available services include:
a software process for presenting statistical information for the user and related to the patient study,
a software process for presenting previous patient studies or cases from the same hospital or imaging center from which the medical image data originated, or
a software process for presenting previous patient studies or cases from the same hospital or imaging center from which the medial image data originated and which were interpreted by the medical service provider.

17. The computer-readable medium of claim 13 wherein each patient study includes an anatomical area,
wherein each modality includes an indication of a medical device associated with the image data; and,
wherein the subset of available services includes connecting to either a medical expert in analyzing image data from the medical device or a medical expert related to the anatomical area.

18. The computer-readable medium of claim 13, further comprising:
providing an on-line store for purchasing at least some of the subset of available services.

19. The computer-readable medium of claim 13 wherein the subset of available services include combining multiple medical images to form a composite image.

20. A system for handling patient data, the system comprising:
means for associating multiple analysis functions with a patient study based at least in part on: a characteristic feature of the patient study, a characteristic feature of a modality corresponding to a patient, and a characteristic feature of the functions,
wherein at least some of the multiple analysis functions correspond to analyzing data of the patient study, and
wherein the multiple analysis functions are a proper subset of functions selected from a set of available analysis functions; and,
means for presenting information corresponding to the patient study and the multiple analysis functions.

21. The system for handling patient data of claim 20, further comprising:
means for receiving an indication of a selected one of the functions; and
means for initiating the selected function, wherein the selected function operates on data of the patient study to generate analysis data.

22. A computer-readable medium storing instructions for a method, wherein the method causes a computer to display multiple medical services, the method comprising:
displaying a subset of available medical services associated with medical diagnostics, wherein the subset of available services is based on a medial modality or a patient study, and
wherein the subset of available services are selected from a larger set of multiple services,
wherein the multiple services include information services and image analysis services; and,
providing an on-line store for purchasing at least some of the subset of available services.
